(19) United States
(12) Patent Application Publication
(10) Pub. No.: US 2007/0064878 A1
(43) Pub. Date: Mar. 22, 2007

(54) Antiscatter grid having a cell-like structure of radiation channels, and method for producing such an antiscatter grid

(76) Inventor: Bjorn Heismann, Erlangen (DE)

Correspondence Address: HARNESS, DICKEY & PIERCE, P.L.C., P.O.BOX 8910, RESTON, VA, 20195, US

(21) Appl. No.: 11/522,486

(22) Filed: Sep. 18, 2006

(30) Foreign Application Priority Data
Sep. 19, 2005 (DE) 10 2005 044 650.7

(51) Int. Cl. G21K 1/00

(52) U.S. Cl. 378/154

(57) ABSTRACT

An antiscatter grid is disclosed which is constructed from lamellas that are opaque to radiation. Further, a method is disclosed for producing such an antiscatter grid. The antiscatter grid includes a cell-like structure with radiation channels respectively surrounded laterally by the lamellas, the lamellas being arranged crossing over at least partially in such a way that at at least a few crossover sites at least one lamella respectively has a slot that is cut out laterally in a fashion substantially in the direction of radiation, in which another lamella is positively arranged. Owing to this shape and this arrangement for the lamellas, they support one another mutually such that they also form a dimensionally stable structure without additional means for holding them.

### PRIORITY STATEMENT

The present application hereby claims priority under 35 U.S.C. § 119 on German patent application number DE 10 2005 044 650.7 filed Sep. 19, 2005, the entire contents of which is hereby incorporated herein by reference.

### FIELD

The invention generally relates to an antiscatter grid having a cell-like structure of radiation channels, and/or to a method for producing an antiscatter grid.

### BACKGROUND

An antiscatter grid is provided for absorbing scattered radiation, particularly in the form of X-radiation or gamma radiation. In X-ray imaging technology, which is applied for example in medical X-ray imaging, a respective examination object is irradiated by an X-ray emitter with X-radiation that emanates in the shape of a fan from a focus of the X-ray emitter. This X-radiation penetrates the examination object and is detected by a radiation detector that acquires X-ray image information on the basis of the detected X-radiation.

A portion of the X-radiation is scattered upon penetrating the examination object, and is thereby deflected from its originally rectilinear path. This scattered radiation would lead to a falsification of the X-ray image information, and so there is usually arranged between the examination object and the X-ray detector, an antiscatter grid that passes to the X-ray detector only the primary radiation penetrating the examination object rectilinearly.

Depending on the field of application, the antiscatter grid has a one or two-dimensional basic structure that include wall-like or web-like elements that are aligned in the direction of the focus of the X-ray emitter. The wall-like and web-like elements include, in this case, a material that is opaque to radiation such that they absorb the scattered radiation.

An antiscatter grid of the abovenamed type is disclosed, for example, in DE 10305106 A1. The antiscatter grid disclosed there is distinguished, inter alia, in that its wall-like or web-like elements are arranged or shaped in such a way that the absorption structure has an irregular, aperiodic pattern.

An antiscatter grid for X-radiation is used, for example, in projection X-ray systems, C-arc X-ray systems and X-ray computed tomography systems. Use is made moreover of an antiscatter grid for gamma radiation in the case of gamma radiation imaging such as, for example, so-called single photon emission computed tomography (SPECT). The antiscatter grid in the meaning described above is frequently denoted as a collimator; consequently, the term of antiscatter grid also includes below designs that can be denoted as collimators.

Since the antiscatter grid is typically constructed from a multiplicity of wall-like or web-like elements, it is generally expensive to produce the antiscatter grid. Various methods are known for producing antiscatter grids, and these may be subdivided into three groups; a few of these methods are described below.

The first group of the methods for producing an antiscatter grid is based on stacking individual layers one above the other. This certainly ensures a stable structure of the antiscatter grid, but these production methods are frequently complicated to carry out. In order to produce an antiscatter grid whose radiation-absorbing walls are aligned with a focus, it is necessary to arrange the through openings for radiation in neighboring layers in a fashion respectively slightly offset from one another such that it is possible to produce layers that differ from one another in a complicated way.

In order to produce antiscatter grids for X-radiation, U.S. Pat. No. 5,814,235 discloses a method in which the antiscatter grid is constructed from layers in the form of individual thin metal foil layers with radiation openings. The individual metal foil layers, which are respectively produced by a photolithographic method with many individual steps including a material that absorbs the X-radiation strongly.

U.S. Pat. No. 6,185,278 B1 discloses a collimator for X-rays and gamma rays that includes collimator layers which are stacked individually one above the other and can, in particular, be produced by way of a photolithographic etching method. This collimator is basically comparable to the antiscatter grid that is produced in accordance with the method described in the abovenamed U.S. Pat. No. 5,814,235. The collimator layers are basically arranged such that their radiation channels are aligned with a focus; in this case, the collimator layers are combined to form groups with an identical arrangement of their through openings such that the number of mutually differing collimator layers is reduced by comparison with the number of metal foil layers required in accordance with U.S. Pat. No. 5,814,235.

The second group of the methods for producing an antiscatter grid is based on the production of a unipartite basic body that either absorbs radiation itself or is coated with a material that absorbs radiation. The unipartite basic body does ensure a stable structure of the antiscatter grid, but these production methods are frequently complicated to carry out and render it difficult to achieve a satisfactory dimensional stability.

In the method known from U.S. Pat. No. 5,303,282 for producing a collimator, a substrate is used that is made from photosensitive material and is exposed in accordance with the radiation channels to be generated by using a photomask. The radiation channels are then etched out of this substrate in accordance with the exposed regions. The surface of the substrate including the inner walls of the through channels are coated with a material that absorbs radiation.

DE 10147947 C1 describes a method for producing an antiscatter grid by using the technique of rapid prototyping. The first step in this method is to establish the geometry of the transparent and opaque regions of the antiscatter grid. Subsequently, a rapid prototyping technique is used to construct a basic body in accordance with the geometry of the transparent regions by layerwise strengthening of a construction material under the influence of radiation. Finally, the antiscatter grid founded on the basic body is finished, in particular by coating the basic body with a material that absorbs radiation.

EP 1182671 A2 discloses an antiscatter grid having a coherently designed grid structure that is flexible along at least one axis in such a way that the alignment with a focus can be set; the grid structure is produced, for example, using an injection molding method from a thermoplastic material to which tungsten is added as a substance that absorbs radiation.

In the third group of the methods for producing an antiscatter grid, sheets, strips or similar that are opaque to radiation are brought into a relative arrangement by using aids such as, for example, holding frames or adhesives; these production methods are rendered expensive by these aids.

DE 10011877 C2 discloses a collimator that is produced by inserting into lateral slots of two lateral parts collimator sheets that are aligned with an X-ray source; this collimator absorbs scattered stray radiation only in one direction.

U.S. Pat. No. 3,943,366 discloses a collimator having walls that absorb radiation and are formed from a multiplicity of parallel strips with flat sections and with sections widened outward that respectively have a middle piece parallel to the flat sections, the flat sections of a strip respectively being bonded to the middle pieces of a neighboring strip such that the strips form a sequence of parallel holes that correspond to the radiation channels. Such a collimator has, in particular, the structure of a honeycomb of which the walls respectively branch in three directions at branching sites.

### SUMMARY

In at least one embodiment of the present invention, an antiscatter grid includes a stable structure despite a capacity for simple production.

A particularly simple production of the antiscatter grid from a multiplicity of individual lamellas is rendered possible by the design of the antiscatter grid from a multiplicity of lamellas which are arranged crossing over one another at least partially and are opaque to radiation, of which at at least a few crossover sites at least one lamella respectively has- a slot that is cut out laterally in a fashion substantially parallel to the direction of radiation and in which another lamella is positively arranged. In this case, the lamellas are arranged in such a way that they form a cell-like structure with radiation channels respectively surrounded laterally by the lamellas. The lamellas support one another mutually owing to the positive arrangement of a lamella in a slot of a respective other lamella, and so the lamellas form a stable structure even without aids.

The antiscatter grid can be used, in particular, to reduce scattered radiation in the form of X-radiation and/or gamma radiation. Depending on the situation in which the antiscatter grid is being applied, it suffices for this purpose when the lamellas are not completely, but only partially opaque to radiation, or absorb radiation partially.

It is provided in accordance with one refinement that at at least a few crossover sites of in each case two lamellas, each of the two lamellas has a slot that is cut out laterally in a fashion substantially parallel to the direction of radiation and points in the direction of the respective other lamella in such a way that the two lamellas mutually engage in one another positively; this enables a particularly stable structure of the antiscatter grid in a simple way.

The antiscatter grid can be produced with particular lack of complication via lamellas of respectively identical shape. The production of only one type of lamellas is in this case particularly cost-effective.

A particularly simple processing of the lamellas for the antiscatter grid is enabled by lamellas that have a substantially rectilinear shape when viewed in the direction of radiation.

A high absorbing power of the antiscatter grid for the scattered radiation, and a high transmitting power for the primary radiation are enabled by way of at least partial alignment of the lamellas with a focus of the radiation.

The antiscatter grid can be produced with particular ease owing to the fact that two lamellas are respectively arranged crossing over one another at right angles at the crossover sites. This results in an antiscatter grid having a two-dimensional basic structure in the form of a rectangular grid.

A particularly simple design of the antiscatter grid with a uniformly distributed absorbing power for scattered radiation is achieved by virtue of the fact that the spacings between the slots in the lamellas are respectively equal. In the case of an antiscatter grid having lamellas respectively arranged at right angles at the crossover sites, this results in an antiscatter grid having a grid-shaped, two-dimensional basic structure with radiation channels that are surrounded by the lamellas and respectively have a square opening cross section. The antiscatter grid having such a grid structure has an equally high absorbing power for scattered radiation given an identical wall thickness of the lamellas in both directions of the lamellas.

A low-complexity design of the antiscatter grid from as few individual lamellas as possible is enabled by way of lamellas whose end faces, which are aligned in a fashion substantially parallel to the direction of radiation, extend up to the edge of the antiscatter grid. The segmentation of a row of lamellas from a number of individual lamellas is, in particular, avoided.

A particularly simple installation of the antiscatter grid is possible owing to a design of the antiscatter grid having an arrangement of lamellas in such a way that their end faces aligned substantially parallel to the direction of radiation define a rectangle; this is achieved, for example, by appropriately selecting the length and arrangement of the lamellas. Moreover, this antiscatter grid permits a number of antiscatter grids of identical design to be Juxtaposed in a simple way.

In accordance with a further refinement, it is provided that the lamellas respectively define a substantially flat surface with their top side and/or underside, which are/is aligned in a fashion essentially perpendicular to the direction of radiation; this enables a particularly compact design of the antiscatter grid. Such a design is achieved, for example, by virtue of the fact that the lamellas respectively have at their crossover sites two interengaging slots that extend over half the width, measured in the direction of radiation, of the respective lamella.

In the case of a computed tomography system, the abovenamed substantially flat surface can be slightly curved in order to adapt the curvature of the X-radiation detector of the X-ray computed tomography system. The curvature of the top side and/or underside of the antiscatter grid follows the shape of a circle with the focus as midpoint in the case of an X-ray computed tomography system, for example, or the shape of a sphere with the focus as midpoint in the case of a system for projection radiography, for example.

A particularly stable arrangement of the lamellas relative to one another is enabled by bonding the lamellas at at least a few of the crossover sites. This is achieved, for example, by adding adhesive into the slot of the lamellas before the lamellas are inserted into one another with their slots. The bonding of the lamellas can also be performed after they are punched together, this being done by adding the adhesive into the angles formed by the lamellas at the crossover sites.

The antiscatter grid is additionally stabilized by virtue of the fact that the end faces and/or the top sides and/or the undersides of at least a few of the lamellas are held by an external holding device of the antiscatter grid. In particular, shearing of the cell-like structure perpendicular to the direction of radiation is avoided. Moreover, at least one holding device that simplify installing the antiscatter grid in a unit can be provided on the holding device. If the holding device covers radiation channels, it is expedient for the holding device include a material that is substantially transparent to radiation. The external holding device can also be formed by the detector. It is also possible that a scintillator arranged upstream of the detector is designed as a holding device, in which the lamellas can, for example, be bonded to the scintillator, in particular with the aid of a reflector adhesive.

Filling up at least a few of the radiation channels at least partially with a filling material that is substantially transparent to radiation devices, on the one hand, that the lamellas are firmly connected to one another and, on the other hand, that the overall arrangement of the lamellas is stabilized against deformation.

A particularly simple production of the lamellas is enabled by way of lamellas made from sheets of a metal that is opaque to radiation. The metals tungsten, molybdenum, tantalum, steel and lead have a high absorbing power for X-radiation and/or gamma radiation, and can therefore respectively be used advantageously as metal for producing the sheets.

In order to avoid one production step for deforming the sheets, the latter are expediently used in rectilinear form as lamellas of the antiscatter grid. An antiscatter grid having lamellas that contain tungsten enables a particularly good absorption of scattered radiation, particularly in the form of gamma radiation. Antiscatter grids made from lead are normally used for imaging based on gamma radiation.

By contrast with lead, tungsten has a greatly enhanced absorbing power for gamma radiation, in particular for gamma radiation of high energy. It is, for example, possible to fabricate the lamellas from a plastic to which tungsten is added as powder. The antiscatter grid having lamellas containing tungsten can be used, in particular, for a radiation detector that detects both X-radiation and gamma radiation. Such detectors can be used, for example, in imaging systems that enable both conventional X-ray computed tomography and SPECT with the aid of only one detector.

### BRIEF DESCRIPTION OF THE DRAWINGS

The invention and further advantageous refinements of the invention are explained below in more detail in the drawing with the aid of schematic example embodiments, without thereby restricting the invention to these example embodiments. In the drawings:

FIG. 1 shows a perspective view of a first lamella with laterally cut-out slots;

FIG. 2 shows a perspective view of an insertion of the first lamella in accordance with FIG. 1 into slots of a multiplicity of further lamellas that are arranged perpendicular to the first lamella;

FIG. 3 shows a plan view of an antiscatter grid having a multiplicity of lamellas arranged crossing over one another;

FIG. 4 shows a side view of the antiscatter grid in accordance with FIG. 3;

FIG. 5 shows a plan view of an antiscatter grid in accordance with FIG. 3, whose radiation channels are filled up with a filling material;

FIG. 6 shows a side view of the antiscatter grid in accordance with FIG. 5;

FIG. 7 shows a plan view of an antiscatter grid in accordance with FIG. 3 having an external holding device for holding the lamellas;

FIG. 8 shows a side view of the antiscatter grid in accordance with FIG. 7;

FIG. 9 shows a plan view of an antiscatter grid in accordance with FIG. 7, whose radiation channels are filled up with filling material; and

FIG. 10 shows a side view of the antiscatter grid in accordance with FIG. 9.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

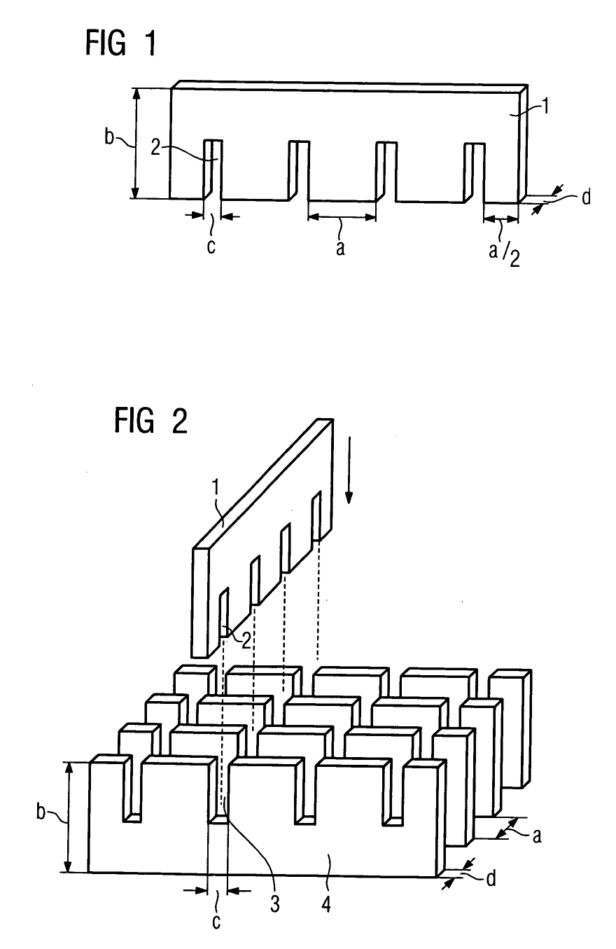

FIG. 1 shows a first lamella 1, which is opaque to radiation and has four slots 2 that are arranged at regular spacings a and extend over half the height b of the first lamella 1, measured in the direction of the slot. In this example embodiment, the first lamella 1 is produced from a tungsten sheet of straight shape. The width c of the slots 2 corresponds substantially to the thickness d of the tungsten sheet.

A multiplicity of lamellas 1 of the type illustrated in FIG. 1 and previously described are provided with a cell-like structure of radiation channels for the purpose of producing an antiscatter grid in a way described in more detail in FIG. 2. The lamellas 1 themselves can be produced by punching, milling or sawing from a lamella blank, for example in the form of a long strip.

FIG. 2 shows an insertion of the first lamella 1 from FIG. 1 into slots 3 of four further lamellas 4 arranged at the respective spacing a parallel to one another and perpendicular to the first lamella 1. The further lamellas 4 are of the same construction as the first lamella 1 and—as illustrated—point with their slots 3 in the direction of the first lamella 1, whose slots 2 point in turn in the direction of the further lamellas 3. As illustrated, the insertion is performed by lowering the first lamella 1 onto the parallel arrangement of the further lamellas 4, in each case one slot 2 of the first lamella 1 being located above in each case one slot 3 of the further lamellas 4.

In the end position of the first lamella 1, the latter is arranged crossed over the further lamellas 4, each of the two lamellas arranged in a crossed over fashion alternately mutually engaging in one another positively at each crossover site of the first lamella 1 with one of the further lamellas 4. It is provided following thereupon that additional lamellas of the same construction as the first lamella 1 are inserted in a fashion parallel to the first lamella 1 into the remaining slots 3 of the further lamellas 4 such that, finally, an antiscatter grid is formed that has a cell-like structure with in each case radiation channels laterally surrounded by the lamellas 1, 3.

For the purpose of additional stabilization, it is possible before inserting the first lamella 1 or the additional lamellas into the further lamellas 4 to provide the slots 2 and 3, respectively, with an adhesive that interconnects the lamellas 1, 4 in the respective end position at their crossover sites.

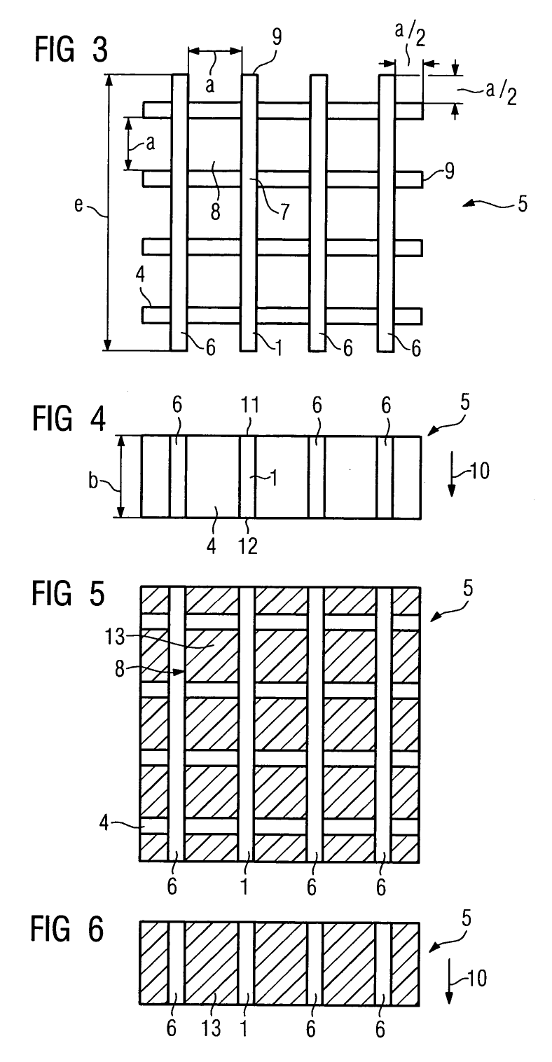

FIG. 3 shows a plan view of the antiscatter grid 5 yielded as product of the production process illustrated partially in FIG. 2. The antiscatter grid 5 includes, on the one hand, the first lamella 1 and the further lamellas 6 aligned parallel thereto and, on the other hand, the further lamellas 4 arranged perpendicular to the abovenamed lamellas 1, 6.

Since, on the one hand, the slots 2, 3 of the lamellas 1, 4, 6 have the same regular spacing a and, on the other hand, respectively two lamellas 1, 4, 6 are arranged crossing over one another at right angles at the crossover sites 7, the antiscatter grid 5 has a regular, cell-like structure with radiation channels 8 respectively surrounded laterally by the lamellas 1, 4, 6 and which respectively have a square cross-sectional surface with a side length a. Since all the lamellas 1, 4, 6 are identical in form, this antiscatter grid 5 can be produced particularly simply.

In the plan view illustrated in FIG. 3 of the antiscatter grid 5, the direction of radiation of the primary radiation is perpendicular to the plane of the illustration; the illustration corresponds, for example, to a view in the direction of radiation. In the previously described arrangement of the lamellas 1, 4, 6, the end faces 9 of the lamellas 1, 4, 6, which are aligned substantially parallel to the direction of radiation, define a rectangle in the form, in this example embodiment, of a square of side length e. This rectangular outer shape of the antiscatter grid 5 enables a simple installation of the antiscatter grid 5 in a unit, particularly also a juxtaposition of a number of identical antiscatter grids 5 for the purpose of forming a larger antiscatter grid. In order to be able in the case of this juxtaposition to continue the regular, cell-like structure, the extensions at the end faces of the lamellas 1, 4, 6 respectively have half the length a/2 of the spacings a of the slots 2 and 3. It is possible to use an adhesive to connect the end faces 9 of lamellas 1, 4, 6 that border one another.

In the example embodiment illustrated, the lamellas 1, 4, 6 respectively extend with their end faces 9, which are aligned in a fashion substantially parallel to the direction of radiation, up to the edge of the antiscatter grid 5, that is to say they cover the antiscatter grid 5 with their lengths. This avoids a segmentation of lamella rows into a number of individual lamellas.

The example embodiment illustrated in FIG. 3 shows a very much simplified antiscatter grid 5 that has only a very low number of lamellas 1, 4, 6. Antiscatter grids typically have a relatively large number of radiation channels 8. Also conceivable instead of the radiation channels 8 with a square cross section are radiation channels with a rectangular and non-square cross section, as well as a cross section in the form of a parallelogram or other geometric shapes. The type of cell-like structure of the antiscatter grid 5 depends on the respective intended use, in particular on the respective radiation and the respective type of unit. It is also possible for three or more lamellas 1, 4, 6 to cross over one another at a crossover site 7. This renders possible, for example, a cell-like structure of radiation channels 8 that have a cross section in the form of equilateral triangles.

FIG. 4 shows the antiscatter grid 5 in accordance with FIG. 3 in a side view. The direction of radiation 10 is indicated by an arrow. The lamellas 1, 4, 6 respectively define with their top sides 11 and undersides 12, aligned substantially perpendicular to the direction of radiation 10, a substantially flat surface that enables a compact design of the antiscatter grid 5 as well as easy installation of the antiscatter grid 5. This compact design is ensured, in particular, by the identical height b of the lamellas 1, 4, 6 as well as the slots 2, 3 respectively extending over half of this height b.

It would also be possible as an alternative for only the further lamellas 4 to have slots 3, while the lamellas 1, 6 perpendicular to these further lamellas 4 have no slots; in this case, the top sides and undersides of the lamellas 1, 4, 6 would not define a common flat surface.

It would be possible for the slots 3 of the further lamellas 4 to be respectively aligned at a slight angle to one another in such a way that the lamellas 1, 6 inserted into these slots 3 are aligned with a focus of a radiation source.

FIG. 5 shows the antiscatter grid 5 in accordance with FIG. 3, the radiation channels 8 being filled up with a filling material 13 which is substantially transparent to radiation. In the example embodiment illustrated in FIG. 5, the radiation channels 8 were filled up with foamed plastic. This plastic fixes the lamellas 1, 4, 6 in their arrangement relative to one another, and prevents a deformation of the cell-like structure of the antiscatter grid 5.

FIG. 6 shows a side view of the antiscatter grid 5 in accordance with FIG. 5.

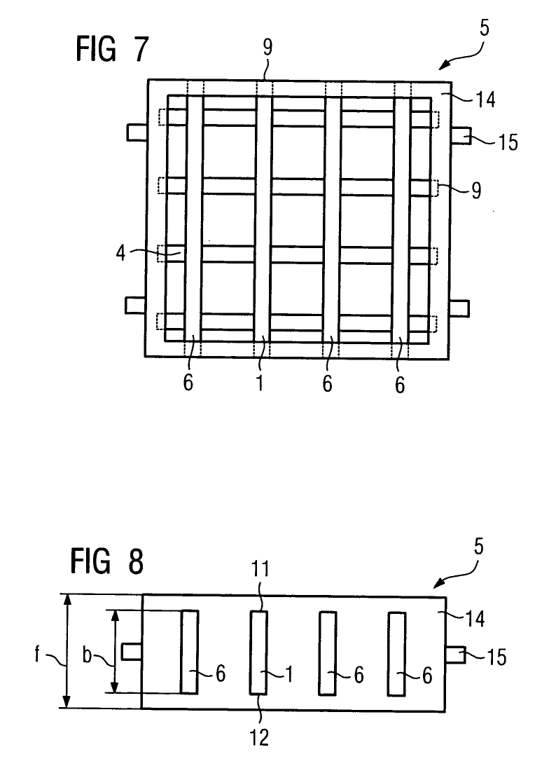

FIG. 7 shows a plan view of the antiscatter grid 5 in accordance with FIG. 3, the end faces 9 of the lamellas 1, 4, 6 being held by an external holding device 14, surrounding the arrangement of the lamellas 1, 4, 6 in a rectangular fashion, of the antiscatter grid 5. The holding device 14 is fabricated from a plastic that is opaque to radiation, and the end faces 9 of the lamellas 1, 4, 6 are cast into it at least partially. Located on the holding device 14 on two opposite sides are upwardly directed holding devices 15 that enable a simple installation of the antiscatter grid 5. The lamellas 1, 6 are cast into the two other opposite sides of the holding device 14 in such a way that their end faces 9 terminate flush with the outside of the holding device. This enables in a simple way a successive juxtaposition of the antiscatter grids 5 at these sides. This type of linear juxtaposition of the antiscatter grids 5 is expedient, in particular, for X-ray computed tomography systems having comparatively narrow X-radiation detectors.

FIG. 8 shows the antiscatter grid 5 in accordance with FIG. 7 in a side view. The height f of the holding device 14 is greater than the height b of the lamellas 1, 4, 6, such that the holding device 14 surrounds the top sides 11 and the undersides 12 of the lamellas 1, 4, 6. This ensures that the lamellas 1, 4, 6 are held in a particularly secure fashion.

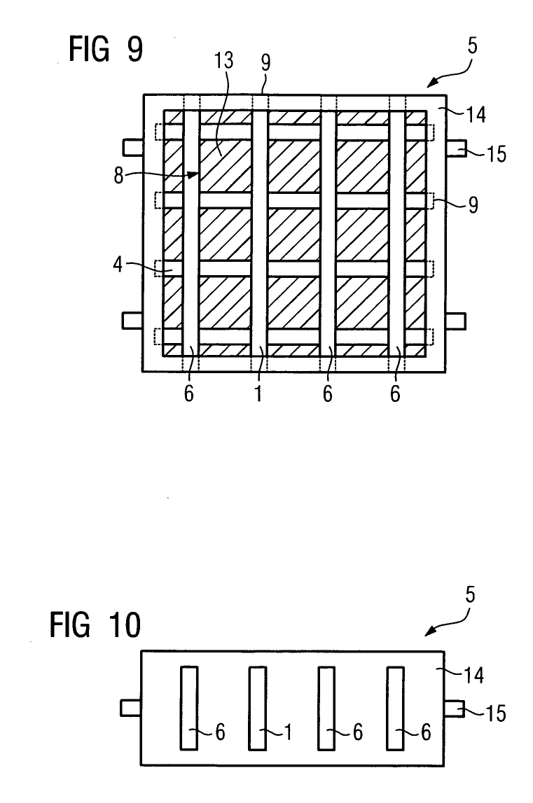

FIG. 9 shows a plan view of the antiscatter grid 5 in accordance with FIG. 7, the radiation channels 8 being—as in FIG. 5—filled up with a filling material 13 in the form of foamed plastic.

FIG. 10 shows the antiscatter grid 5 in accordance with FIG. 9 in a side view.

A possible embodiment of the antiscatter grid constructed from lamellas that are opaque to radiation can be described in summary as follows: the antiscatter grid has a cell-like structure with radiation channels respectively surrounded laterally by the lamellas, the lamellas being arranged crossing over at least partially in such a way that at at least a few crossover sites at least one lamella respectively has a slot that is cut out laterally substantially in the direction of radiation, in which another lamella is positively arranged; the lamellas support one another mutually owing to this shape and this arrangement such that they also form a dimensionally stable structure without additional devices/methods for holding them.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An antiscatter grid comprising:
a plurality of lamellas arranged at least partially crossing over one another, the lamellas being substantially opaque to radiation and forming a cell-like structure of radiation channels, respectively surrounded laterally by the lamellas, in which at at least a few crossover sites, at least one lamella respectively includes a slot that is cut out laterally in a fashion substantially parallel to the direction of radiation and in which another lamella is positively arranged.

2. The antiscatter grid as claimed in claim 1, wherein at at least a few crossover sites of two lamellas, each of the two lamellas includes a slot that is cut out laterally in a fashion substantially parallel to the direction of radiation and points in the direction of the respective other lamella in such a way that the two lamellas mutually engage in one another positively.

3. The antiscatter grid as claimed in claim 1, wherein the lamellas respectively are of an identical shape.

4. The antiscatter grid as claimed in claim 1, wherein the lamellas include a substantially rectilinear shape when viewed in the direction of radiation.

5. The antiscatter grid as claimed in claim 1, wherein the lamellas are aligned at least partially with a focus of the radiation.

6. The antiscatter grid as claimed in claim 1, wherein two lamellas are respectively arranged crossing over one another at right angles at the crossover sites.

7. The antiscatter grid as claimed in claim 1, wherein the spacings between the slots are respectively equal.

8. The antiscatter grid as claimed in claim 1, wherein the lamellas extend up to the edge of the antiscatter grid with their end faces, aligned in a fashion substantially parallel to the direction of radiation.

9. The antiscatter grid as claimed in claim 1, wherein the lamellas define a rectangle with their end faces.

10. The antiscatter grid as claimed in claim 1, wherein the lamellas respectively define a substantially flat surface with at least one of their top side and underside, which is aligned in a fashion essentially perpendicular to the direction of radiation.

11. The antiscatter grid as claimed in claim 1, wherein the lamellas are bonded to one another at at least a few of the crossover sites.

12. The antiscatter grid as claimed in claim 1, wherein at least one of the end faces, the top sides and the undersides of at least a few of the lamellas are held by an external holding device of the antiscatter grid.

13. The antiscatter grid as claimed in claim 1, wherein at least a few of the radiation channels are filled up at least partially with a filling material that is substantially transparent to radiation.

14. The antiscatter grid as claimed in claim 1, wherein the lamellas consist of sheets made from a metal that is opaque to radiation.

15. The antiscatter grid as claimed in claim 1, wherein the lamellas contain tungsten.

16. A method for producing an antiscatter grid including a cell-like structure of radiation channels, comprising:
providing a plurality of lamellas substantially opaque to radiation, at least partially including laterally cut-out slots substantially parallel to a prescribed direction of radiation; and
inserting respectively one of the lamellas into at least one of the slots of respectively at least one further one of the lamellas to form a crossed-over, positive arrangement in relation to one another in such a way that the cell-like structure is formed by the lamellas laterally surrounding the radiation channels.

17. The method as claimed in claim 16, wherein at at least a few provided crossover sites of two lamellas, each of the two lamellas is inserted into a slot of the respective other lamella, such that the two lamellas mutually engage in one another positively with their slots respectively pointing in the direction of the respective other lamella.

18. The method as claimed in claim 16, wherein the lamellas are provided in one design with a shape that is respectively identical.

19. The method as claimed in claim 16, wherein the lamellas are provided in one design with a shape that is substantially rectilinear when viewed in the direction of radiation.

20. The method as claimed in claim 16, wherein the lamellas are aligned at least partially with a focus of the radiation.

21. The method as claimed in claim 16, wherein two lamellas are respectively arranged crossing over one another at right angles at the crossover sites.

22. The method as claimed in claim 16, wherein, in one design, the lamellas are provided with respectively equal spacings between their slots.

23. The method as claimed in claim 16, wherein the lamellas are provided with such a shape and are inserted in such a way that they extend up to the edge of the antiscatter grid with their end faces, aligned in a fashion substantially parallel to the direction of radiation.

24. The method as claimed in claim 16, wherein the lamellas are provided with such a shape and are inserted in such a way that they define a rectangle with their end faces.

25. The method as claimed in claim 16, wherein the lamellas are provided with such a shape and are inserted in such a way that they respectively define a substantially flat surface with at least one of their top side and underside, which is aligned in a fashion essentially parallel to the direction of radiation.

26. The method as claimed in claim 16, wherein the lamellas are bonded to one another at at least a few of the crossover sites.

27. The method as claimed in claim 16, wherein at least one of the end faces, the top sides and the undersides of at least a few of the lamellas are arranged held by an external holding device of the antiscatter grid.

28. The method as claimed in claim 16, wherein at least a few of the radiation channels are filled up at least partially with a filling material that is substantially transparent to radiation.

29. The method as claimed in claim 16, wherein, in one design, the lamellas are prepared from sheets made from a metal that is opaque to radiation.

30. The method as claimed in claim 16, wherein the lamellas are prepared in a design containing tungsten.

31. The method as claimed in claim 16, for producing an antiscatter grid including a plurality of lamellas arranged at least partially crossing over one another, the lamellas being substantially opaque to radiation and forming a cell-like structure of radiation channels, respectively surrounded laterally by the lamellas, in which at at least a few crossover sites, at least one lamella respectively includes a slot that is cut out laterally in a fashion substantially parallel to the direction of radiation and in which another lamella is positively arranged.

32. The antiscatter grid as claimed in claim 1, wherein the lamellas respectively are of an identical shape.

33. The antiscatter grid as claimed in claim 1, wherein the lamellas include sheets made from a metal that is opaque to radiation.

34. The antiscatter grid as claimed in claim 1, wherein the lamellas consist of sheets made from at least one of tungsten, molybdenum, tantalum, steel and lead.

35. The antiscatter grid as claimed in claim 1, wherein the lamellas include sheets made from at least one of tungsten, molybdenum, tantalum, steel and lead.

36. The method as claimed in claim 17, wherein the lamellas are provided in one design with a shape that is respectively identical.

37. The method as claimed in claim 16, wherein, in one design, the lamellas are prepared from sheets made from at least one of tungsten, molybdenum, tantalum, steel and lead.
